(19) United States
(12) Patent Application Publication
(10) Pub. No.: US 2016/0034649 A1
(43) Pub. Date: Feb. 4, 2016

(54) INTEGRATED HEALTH AND WEALTH ACCOUNT SYSTEM AND METHOD

(71) Applicant: Venkata Rajamannar Madabhushi, Cincinnati, OH (US)

(72) Inventor: Venkata Rajamannar Madabhushi, Cincinnati, OH (US)

(73) Assignee: HUMANA INC., Louisville, KY (US)

(21) Appl. No.: 13/038,943

(22) Filed: Mar. 2, 2011

Related U.S. Application Data
(60) Provisional application No. 61/309,680, filed on Mar. 2, 2010.

(51) Int. Cl. G06Q 10/00; G06Q 40/06; G06Q 40/08; G06Q 40/00; G06Q 50/00

(52) U.S. Cl. CPC G06F 19/328; G06Q 40/08; G06Q 40/06

(57) ABSTRACT

A computerized method and system for managing a multi-function, integrated account. The account may span multiple legal entities and contain both health and wealth data. The account may contain data pertaining to participants' health insurance, supplemental insurance, and other types of insurance (both health and non-health) and may track payment data, claim data, co-pays, etc. as well as data pertaining to the health of participants. Health data may further comprise information pertaining to participants' weight, body mass index, blood pressure, and fitness level. The multi-function account comprises financial data such as investment data, brokerage data, mortgage data, and savings, debit, and credit account data. Participants are further rewarded for partaking in certain health and financial activities and for performing certain health and financial tasks. Participants may dial a single telephone number or access a single web site in order to access the health and wealth data of the multi-function account.

### CROSS-REFERENCE TO RELATED APPLICATIONS

This application claims priority to U.S. Provisional Patent Application Ser. No. 61/309,680, filed Mar. 2, 2010, titled INTEGRATED HEALTH AND WELLNESS ACCOUNT SYSTEM AND METHOD, the content of which is incorporated herein by reference.

### FIELD OF THE INVENTION

The present invention relates to computerized system for account management and statement generation. In particular, the invention relates to computerized systems for managing multi-function, integrated accounts that may span multiple legal entities and methods of using the same.

### BACKGROUND AND SUMMARY OF THE INVENTION

Maintaining a healthy lifestyle is important for numerous reasons. First, it has a huge impact on the quality of a person's life. People who are healthy tend to be happier, and more successful in day-to-day endeavors. Furthermore, as the life span of individuals continues to grow, leading a healthy lifestyle increases the odds that the later years of life are enjoyable. Second, maintaining a healthy lifestyle can have an impact on the costs of health care. Individuals who are healthy tend to require less medication, less treatment for ailments, less hospital time, etc.

Unfortunately, there are many existing factors that encourage individuals to lead an unhealthy lifestyle. The increasing convenience of many technologies has caused people to be more sedentary than ever before. Teens and adults in particular are spending more and more time in front of televisions and computers and less and less time partaking in healthy activities such as physical exercise. Additionally, hard economic times have made eating relatively inexpensive fast food a more regular event for many people.

There is a need in the art for a system and method of accounting for the healthy activities of individuals and rewarding them for making decisions and taking actions that tend to make them healthier overall. In one exemplary embodiment, the system of the present invention comprises a computerized system for managing a multi-function, integrated account that spans multiple legal entities. In exemplary embodiments, the account may contain both health and wealth data. In one exemplary embodiment, a multi-function health and wellness account comprises health data. A multi-function account may contain data pertaining to individual participants' health insurance, supplemental insurance, and other types of insurance (both health and non-health). In some exemplary embodiments, the multi-function account tracks payment data (such as insurance payments that have been made by participants), claim data (insurance claims that have been filed by participants), denial data, deductibles, co-pays, etc. and also tracks data pertaining to the health of participants. Health data within the account may comprise information pertaining to the weight, body mass index, blood pressure, fitness level, blood sugar levels, prescriptions, etc., of participants.

In one exemplary embodiment, a multi-function health and wellness account comprises health data as well as financial data pertaining to individual participants. The financial data may comprise investment data, brokerage data, mortgage data, spending account data, savings account data, credit account data, debit account data, credit score, loan data, etc. In one exemplary embodiment, the financial data for an individual participant is from a single financial institution. In another exemplary embodiment, the financial data for an individual participant is from more than one financial institution. In a preferred exemplary embodiment, where a multifunction account comprises health and wealth data, individual participants are rewarded points for partaking in certain health and financial activities and for performing certain health and financial tasks.

Some exemplary embodiments of the system and method comprise a telephone inquiry system where individual participants may dial a single telephone number in order to access the health and wealth data of a multi-function account. Exemplary embodiments may also comprise a website that may be accessed with a remote computer where individual participants may review account data by logging into the website. A preferred exemplary embodiment may comprise a membership card that may be utilized in the reward and redemption of program points.

### BRIEF DESCRIPTION OF THE DRAWINGS

FIG. 1 shows an exemplary embodiment of an integrated account system comprising a telephone switch that routes callers to a first entity or a second entity depending on whether they want to inquire about health activities or wealth activities.

FIG. 2 shows an exemplary embodiment of a user interface of an integrated account system.

FIG. 3 shows a flow chart of an exemplary embodiment of a mobile function of an exemplary integrated account system.

FIG. 4 shows an exemplary embodiment of an integrated account system generating a single statement where the statement is compiled by obtaining data from a first entity and a second entity.

FIG. 5 shows a flow chart indicating how an integrated account system database may receive a wealth account number that coordinates to a first entity and a health account number from a second entity and generates an account number for an integrated account. In this exemplary embodiment, the account numbers coordinating to the first and second entity can then be utilized by the database to route individuals to the integrated account.

FIG. 6 shows a depiction of an exemplary embodiment of a rewards program of the present system wherein the activities of two separate entities are integrated and reward points may be earned by an individual user for activities performed for both entities.

FIG. 7 shows a flow chart of an exemplary embodiment of a rewards program where reward points are being awarded for both health and wealth based activities into a single integrated account.

### DETAILED DESCRIPTION

In one exemplary embodiment, the system of the present invention comprises a computerized system and method for managing a multi-function, integrated account that spans multiple legal entities. In exemplary embodiments, the account may contain both health and wealth data. In these exemplary embodiments, the multiple legal entities may comprise an insurance provider and a financial institution such as a bank. In other exemplary embodiments, the multi-function integrated account contains both health and wealth data yet spans only a single entity. The single entity may be a holding company formed by more than one legal entity, a joint venture entity, etc. In one preferred exemplary embodiment, health and wealth data within the integrated account is tracked for an individual participant associated with the account and reward points are awarded to the individual based on his or her performance of various financial and wellness oriented activities.

In a preferred exemplary embodiment, an integrated health and wellness account comprises health data. A multi-function, integrated account may contain data pertaining to individual participants' health insurance, supplemental insurance, and other types of insurance (both health and non-health). In some exemplary embodiments, the multi-function account tracks payment data (such as insurance payments that have been made by participants), claim data (insurance claims that have been filed by participants), denial data, deductibles, co-pays, etc. and also tracks data pertaining to the health of participants. Health data within the account may comprise information pertaining to the weight, body mass index, blood pressure, fitness level, blood sugar levels, prescriptions, etc of participants. In one exemplary embodiment, an integrated account comprises health data that comes from a health account maintained by a single entity.

A multi-function integrated account may contain different types of health data depending on the individual participant associated with the account. For example, an individual participant with a family history of heart disease may have cholesterol levels and stress test results tracked in her multi-function account while another individual who is obese may have weight data and BMI data tracked in his multi-function account. In some exemplary embodiments, individual participants determine what health data is tracked in their multi-function account. In some exemplary embodiments, physicians of individual participants assist in determining what data is tracked in the participants' accounts. In some exemplary embodiments, the multi-function account may comprise data evidencing authorization given by individual participants for the release of their medical information.

In a preferred exemplary embodiment, an integrated health and wealth account comprises health data and financial data pertaining to individual participants. The integrated account number may be stored in a database and associated with a health account number and a wealth account number, each of which facilitates access to data at respective databases. The financial data may comprise investment data, brokerage data, mortgage data, spending account data, savings account data, credit account data, debit account data, credit score, loan data, etc. In one exemplary embodiment, the financial data for an individual participant is from a single financial institution. In another exemplary embodiment, the financial data for an individual participant is from more than one financial institution. Financial data from a financial institution may be an individual's payment record on his or her mortgage which is held by the financial institution, the balance of a checking or savings account held by the financial institution, the balance on a credit account provided by the financial institution, etc. In some exemplary embodiments, an integrated account containing financial data may comprise financial data that does not come directly from a financial institution. This data may include but is not limited to inheritance data, gambling winning/loss data, etc.

In an exemplary embodiment, where a multi-function integrated health and wellness account comprises both health and financial data, individual participants may receive a single unified statement that contains both health/wealth information and financial information. In a preferred exemplary embodiment, the health/wealth information within the unified statement of an individual participant comprises data from the individual's insurance provider while the financial information within the statement comprises data from the individual participant's bank. The data may be retrieved from different databases using the respective health account number and wealth account number associated with the integrated account number.

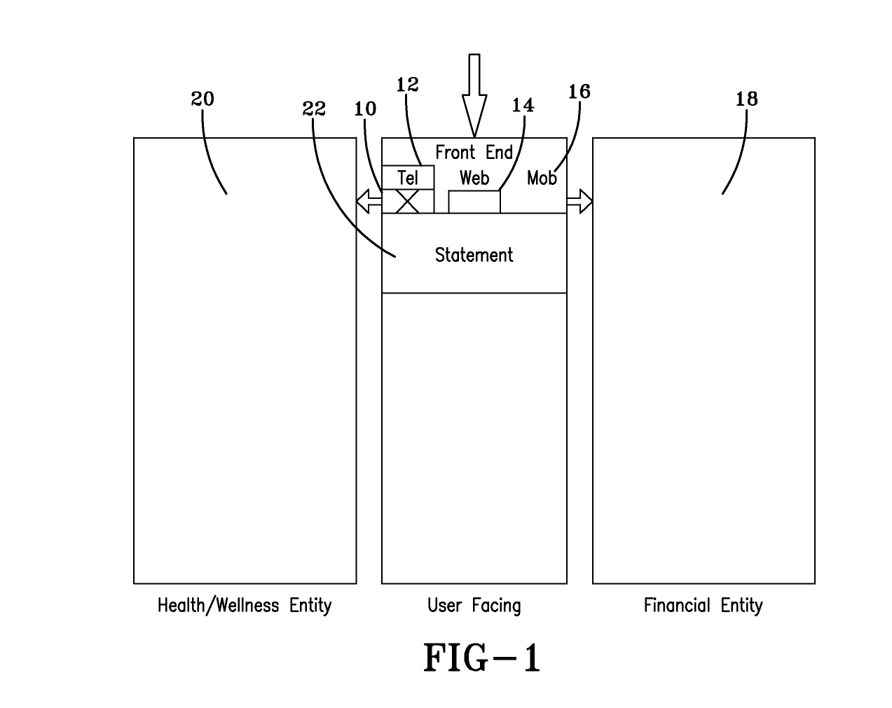

In one exemplary embodiment, individual participants may access all the data within their multi-function integrated account by calling a single telephone number. FIG. 1 shows an exemplary embodiment of how integrated account data 22 may be accessed by a telephone 12 or mobile phone 16. In some exemplary embodiments, the number is a toll-free number. In a preferred exemplary embodiment, where the multi-function integrated account spans multiple legal entities 18, 20 once an individual participant has dialed the single telephone number for account access, he or she is prompted to press certain numbers on his or her phone 10 depending on the type of data he or she wishes to access. For example, if a multi-function account contains mortgage data for an individual participant that comes from the individual's bank 18 and also contains the individual's insurance claim data from the individual's health insurance provider 20, upon calling the single number the individual is asked to enter a first number to be connected to the individual's bank and a second number to be connected to the individual's insurance provider. In another exemplary embodiment, the single number may provide access to the health and finance data of the multi-function account without connecting individual participants to the legal entities which are spanned by the multi-function account.

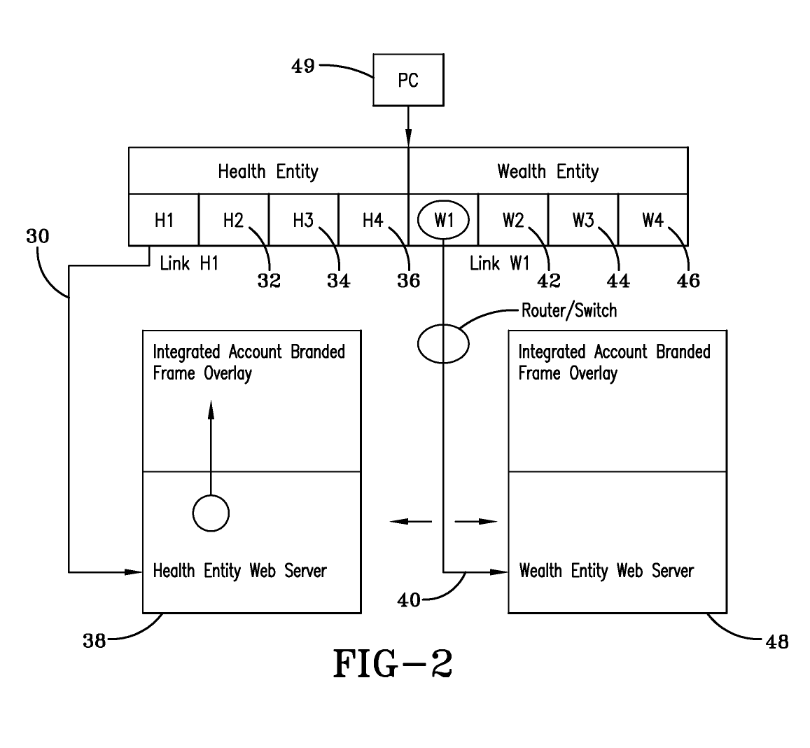

One exemplary embodiment of an integrated account system comprises a web-based user interface 14. In one exemplary embodiment, where a multi-function health and wellness account comprises both health and financial data, individual participants may access all the data within their multi-function account through a user interface that comprises a website. FIG. 2 shows an exemplary embodiment of user interface logic flow of the present system. H1 30 is a link providing claims information at a health entity web server 38, H2 32 is a link to wellness information, H3 34 is a link to medication data, and H4 36 is a link to doctor/care provider information. W1 40 is a link to credit card data from a wealth entity web server 48, W2 42 is a link to investment data, W3 44 is a link to mortgage data, and W4 46 is a link to checking account data.

In a preferred exemplary embodiment, the website is maintained at a server. In an exemplary embodiment where a website is provided for account access, individuals may access the website from a remote computer 49. The servers maintaining the website may transmit to the remote computer a request to enter login information. Upon having received the requested log-in data, a server may transmit a main account page to the remote computer for viewing. The main account page of a multi-function account may comprise background information for the individual participant that has accessed his or her account through the website and may also comprise prompts for the entry of commands. In one exemplary embodiment, a prompt for the entry of a command asks the individual participant to indicate what type of account data he or she would like to have transmitted to the remote computer for viewing. In a preferred exemplary embodiment, the server receives a command from the remote computer to transmit health and wellness data. Upon receiving the request, the server may retrieve health and wellness data for the individual participant from a database at a health entity web server 38 and transmit it to the remote computer for viewing. In another preferred exemplary embodiment, the server receives a command from the remote computer to transmit financial data from a wealth entity web server 48. Upon receiving the request, the server may retrieve financial data for the individual participant from a database and transmit it to the remote computer for viewing. In some exemplary embodiments, a single database comprises both health data and financial data for individual participants while in other exemplary embodiments, a first database comprises health data while a second database comprises financial data. In an exemplary embodiment, comprising a first database and second database, the server transmitting the website may process commands received from the remote computer to determine which database to access in order to retrieve the appropriate data.

In one exemplary embodiment, where a website may be accessed in order to retrieve and review multi-function account data and where the multi-function account spans two legal entities, the website may contain data coming from the first legal entity in a first portal and data coming from the second legal entity in a second portal. In a preferred exemplary embodiment, a website comprises multiple links 30, 32, 34, 36, 40, 42, 44, 46 where each link is associated with different types of data. A link associated with data may cause the data to be displayed on a computer screen by selecting the link with a mouse, touch screen, etc. In some exemplary embodiments, the multi-function account spans more than two legal entities and there are more than two portals within the website where each portal relates to a single legal entity. In some exemplary embodiments, the website of the multi-function account comprises branding for each of the legal entities contributing data to the account.

In one exemplary embodiment where data of the multi-function account may be accessed via a website, the website may comprise data that is intended to promote a healthy lifestyle. In some embodiments, the data is individually tailored to the individual participant accessing the website. For example, if an individual participant has recently quit smoking, the website may transmit articles that discuss the benefits of a cigarette-free lifestyle to a remote computer for viewing upon receiving the individual participants log-in information and a request to view the articles. In another example where an individual participant is trying to lose weight, the website may transmit articles discussing low-calorie meal options to a remote computer for viewing upon receiving the individual participants log-in information and a request to view the articles. In some exemplary embodiments, individual participants are able to limit the transmission of data that promotes a healthy lifestyle. A website of a multi-function account may also contain links to other websites. These links may be to the websites of retailers that sell products promoting a healthy lifestyle, the websites of health and fitness clubs, calorie tracking websites, etc. In some exemplary embodiments, the multi-function account website incorporates portions of these websites. For example, a multi-function account website may transmit a calorie tracking tool, a page that enables the purchase of products that promote a healthy lifestyle, etc.

In another exemplary embodiment, accessing a website may permit individual participants to make changes to their multi-function account. In some embodiments, individual participants may log into a website and enter health information into their multi-function account. In other embodiments, participants may remove data from their multi-function account by logging into the website. In one example, an individual participant may decide he or she no longer wants his or her data (such as cholesterol levels, weight, blood sugar levels, T-cell count, etc.) tracked in the multi-function account so he or she logs into the website and transmits a request that the data no longer be tracked. In one exemplary embodiment, the receipt of such a request causes data that has already been tracked to be deleted from a database.

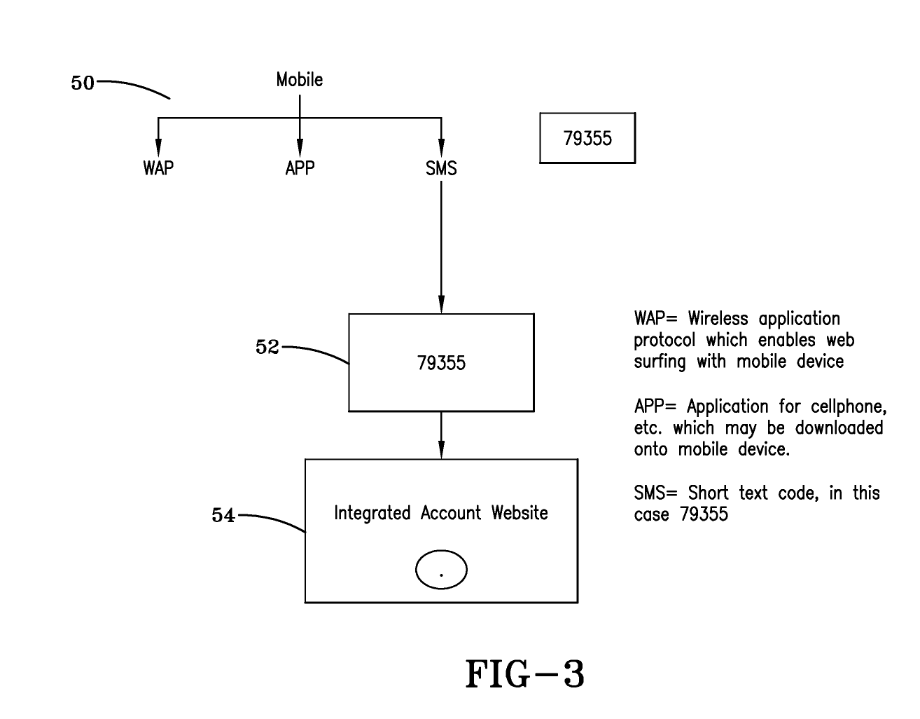

In one exemplary embodiment, an exemplary integrated account system comprises a portable, electronic device. In a preferred exemplary embodiment, the portable electronic device is a mobile phone. FIG. 3 shows an exemplary embodiment of an integrated account system comprising a mobile phone 50. WAP is a wireless application protocol and the mobile phone may be utilized to access a website of the present invention where the website may utilize the logic flow of FIG. 2. In an exemplary embodiment, comprising a mobile phone and comprising a web site, the mobile phone may be utilized to access the website. The website may be modified for sufficient display by the phone's screen. In a preferred exemplary embodiment, all of the data of an integrated account may be accessed with a mobile phone that has accessed the website of the integrated account 54. Some exemplary embodiments comprise mobile phone applications 50 that enable access to integrated account data using a SMS text code 52.

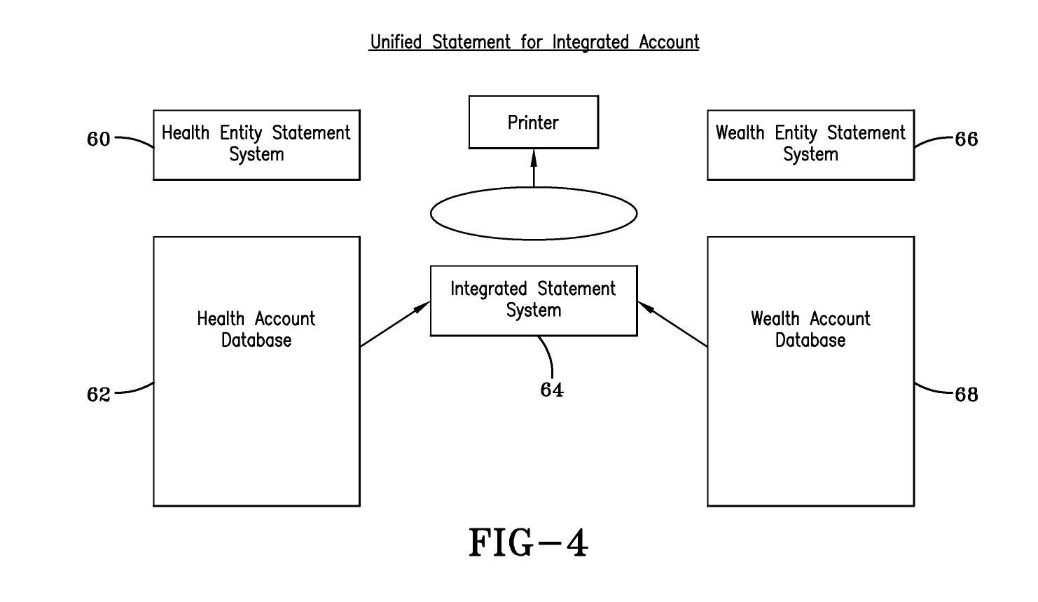

FIG. 4 illustrates an exemplary embodiment of the generation of a unified statement where the statement is generated by an integrated account after having obtained health data 62 from an individual user's insurance provider statement system 60 and wealth data 68 from an individual user's bank statement system 66. In some exemplary embodiments, the unified statement 64 is electronically transmitted to individual participants while in some embodiments the unified statement is printed and physically delivered to individual participants (for example through the mail). In some exemplary embodiments, individual participants are able to specify the form in which they receive their unified statement.

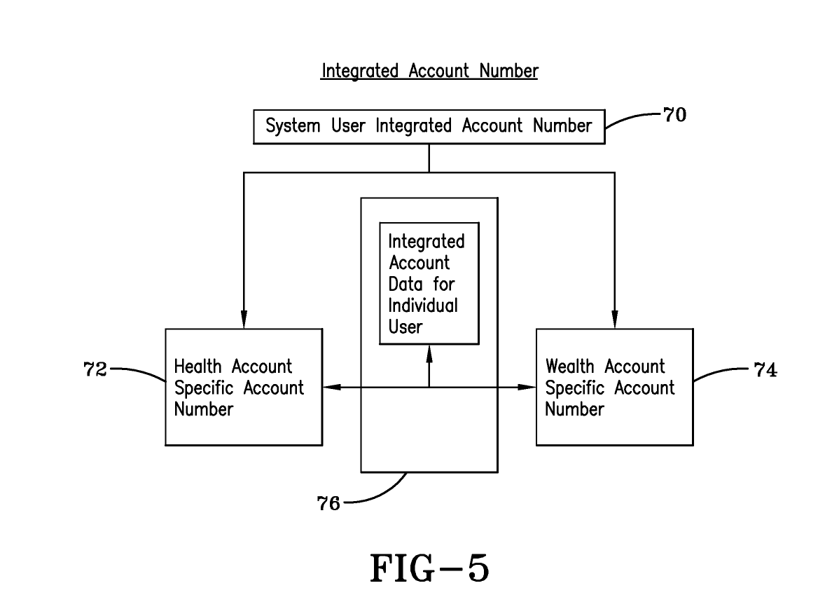

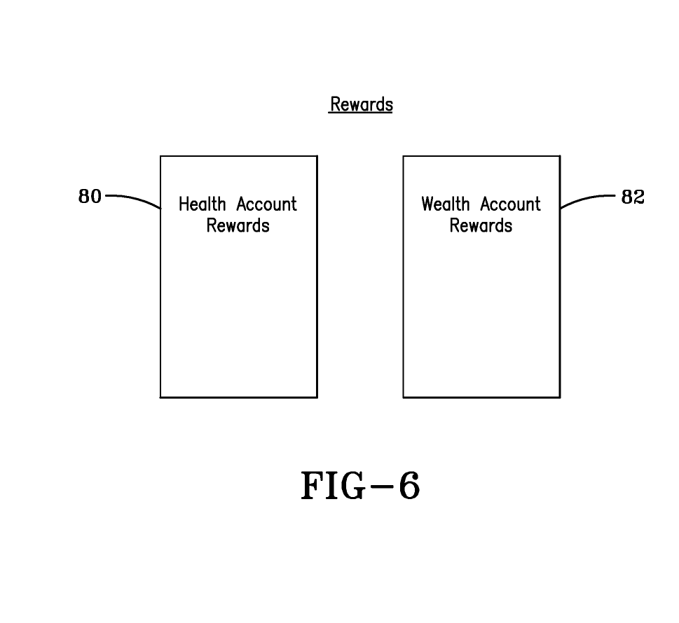

FIG. 5 shows a flow chart of an exemplary method of generating an integrated account number 70 from the health specific account number 72 and wealth specific account number 74 for an individual user. The account numbers may be provided by two separate legal entities. In such an exemplary embodiment, the account numbers of the multiple legal entities may be utilized to access information in an integrated account. In some exemplary embodiments, the integrated account number 70 is utilized to access integrated account data 76. Referring to FIG. 6, an integrated account number may be utilized to earn and redeem reward points associated with either the health account 80 and/or the wealth account 82. A system of the present invention may comprise a membership card comprising the integrated account number of an individual user.

In one exemplary embodiment, a multi-function health and wellness account may be utilized to reward individual participants for a variety of financial oriented tasks. For example, an individual may receive reward points when he or she signs up for the electronic payment of a recurring cost (such as the payment of an electric bill) through a specified financial account (such as a checking, savings, or credit card account). The same individual may also receive reward points when he or she uses the specified financial account at a designated retailer. In exemplary embodiments, retailers may be designated because they promote a healthy lifestyle. For example, certain gyms and health clubs may be designated retailers such that when an individual makes a payment to the retailers from the specified financial account, he or she earns reward points. Retailers may be designated by account managers such that all participants may earn reward points by doing business there, but in some exemplary embodiments, retailers may be designated by individual participants. There may be a limit placed on the number of retailers that may be designated at a given time. In some exemplary embodiments, both individual participants and account managers may designate retailers.

The rewarding of points may be accomplished in a manner that promotes healthiness. In addition to designating retailers based on the fact that they promote a healthy lifestyle, rewards may increase the more an individual frequents a designated retailer. Utilizing the example of a gym being a designated retailer, an individual may earn X number of points the first month he or she utilizes a specified financial account at the gym, 2× number of points the second month he or she utilizes a specified financial account at the gym, 3× number of points the third month, and so on.

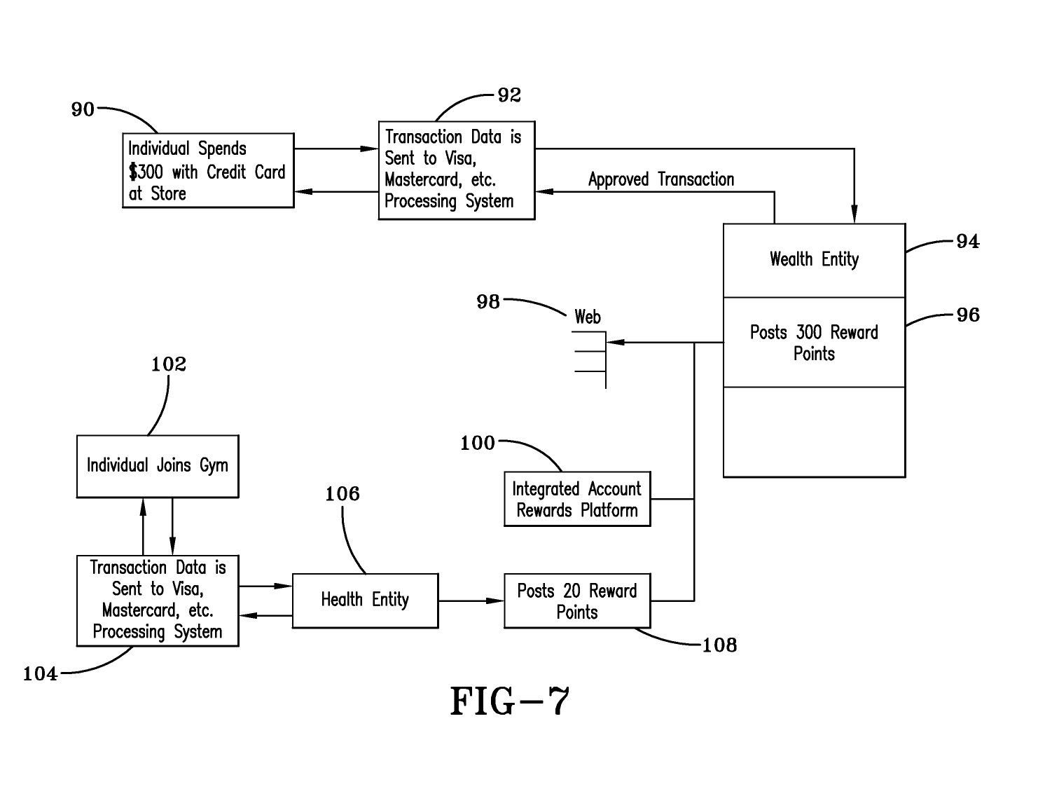

In a preferred exemplary embodiment, a multi-function health and wellness account rewards individuals for a variety of financial and wellness oriented acts. FIG. 7 also shows an exemplary embodiment of a rewards program rewarding points for both financial and wellness activities. Wellness oriented acts for which points are rewarded may be catered towards individual participants. For example, if a participant is overweight he or she may receive rewards points for joining a gym 102. Transaction data for the gym membership 104 is transmitted to the health entity 106. Reward points are then posted to the participant's health account 108. Similarly, an individual participant may have a goal to become more physically fit and the multi-function account can be credited with reward points when that individual achieves a certain physical goal such as running a marathon.

Additionally, financial activities may be rewarded. The participant may spend charge $300 to a credit card 90. Transaction data for the purchase 92 is transmitted to the wealth entity 94. Reward points are then posted to the participant's wealth account 96. The participant may then access a web site 98 and an integrated account rewards platform 100 to view account and rewards data for the health and wealth account.

In some exemplary embodiments, rewarded points may be credited to the multi-function account based on a variety of financial and wellness oriented acts. The crediting of points to an account may be done in a way that encourages healthy lifestyle choices. In some exemplary embodiments, individual participants may be able to determine when points are to be credited to the multi-function account based on certain personal goals. For example, a participant may have a goal to eat at a certain fast food restaurant no more than twice every 30 days. The multi-function account can be set up such that reward points are credited if the individual utilizes a specified financial account to pay for that restaurant's product more than twice in a 30 day period. Similarly, a multi-function account may be credited with reward points if an individual stops making recurring payments to a gym or fitness club. There are a variety of ways a multi-function account can be credited with reward points in a manner that promotes a healthy lifestyle.

In an exemplary embodiment, where the data of a multi-function account can be accessed and retrieved via a website, the website may permit individual participants to monitor reward points. A website may also permit individual participants to purchase a variety of products and services with their rewards points. In other exemplary embodiments, a website of a multi-function account permits individual users to utilize rewards points to make a payment to one or more legal entities. For example, if an insurance company provides data pertaining to an individual participant to his or her multi-function account, the website of the multi-function account may be utilized to pay for the individual participant's insurance provided by the company with the individual participant's reward points.

In one exemplary embodiment, reward points are accessible by individual participants through a spending vehicle such as a credit card. In other exemplary embodiments, reward points are not accessible through a spending vehicle but are linked to a spending vehicle account.

A preferred exemplary embodiment of the present system comprises an integrated account number. In exemplary embodiments, spanning more than one legal entity, each entity may have an account number associated with an individual user of an integrated account. The two separate account numbers may be utilized to generate a third account number for the individual user where the third account number is his or her integrated account number. The integrated account number may facilitate access to the respective accounts at each legal entity. The use of the integrated account number allows to two entities that have previously provided health or wealth account-based services to their customers to partner and provide integrated services to their customers.

While certain embodiments of the present invention are described in detail above, the scope of the invention is not to be considered limited by such disclosure, and modifications are possible without departing from the spirit of the invention as evidenced by the claims. For example, details of a related rewards program may be varied and fall within the scope of the claimed invention. Other aspects of account integration may be varied and fall within the scope of the claimed invention. One skilled in the art would recognize that such modifications are possible without departing from the scope of the claimed invention.

1. A computerized method for presenting account information comprising:
one or more servers executing programming instructions to:
(a) receive a health account number for an individual;
(b) receive a wealth account number for said individual;
(c) generate an integrated account number;
(d) store in a database in association with said integrated account number:
(1) said health account number and said wealth account number; and
(2) user preferences for tracking health data;
(e) receive from a user computer said integrated account number;
(f) retrieve from a health account database health data using said health account number associated with said integrated account number, said health data comprising at least:
(i) health insurance payment data;
(ii) health insurance claim data; and
(iii) health condition data regarding one or more of said individual's medical conditions selected according to said user preferences for tracking health data;
(g) retrieve from a wealth account database wealth data using said wealth account number associated with said integrated account number, said wealth data comprising financial data selected from the group consisting of investment data, brokerage data, mortgage data, spending account data, checking account data, savings account data, credit account data, debit account data, credit score data, and loan data;
(h) generate display data comprising said health data and said wealth data; and
(i) transmit said display data to said user computer.

2. The computerized method of claim 1 wherein said health data further comprises data selected from the group consisting of:
denied claim data, insurance deductible data, and insurance co-pay data.

3. (canceled)

4. The computerized method of claim 1 wherein the programming instruction to display data comprising said health data and said wealth data comprises displaying rewards points in said health account and in said wealth account.

5. A computerized method for presenting account information comprising one or more servers executing programming instructions to:
(a) receive a health account number for an individual;
(b) receive a wealth account number for said individual;
(c) generate at said server an integrated account number;
(d) store in an integrated account database said integrated account number associated with:
(1) said health account number for an account comprising health data, said health data comprising at least:
(i) health insurance payment data;
(ii) health insurance claim data; and
(iii) health condition data regarding one or more of said individual's medical conditions; and
(2) said wealth account number for an account comprising financial data selected from the group consisting of investment data, brokerage data, mortgage data, spending account data, checking account data, savings account data, credit account data, debit account data, credit score data, and loan data; and
(3) user preferences for tracking health data;
(e) receive from a user computer said integrated account number;
(f) retrieve from said integrated account database said health account number associated with said integrated account number;
(g) retrieve from a health account database health data associated with said health account number, said health data comprising health condition data selected according to said user preferences for tracking health data;
(h) retrieve from said integrated account database said wealth account number associated with said integrated account number;
(i) retrieve from a wealth account database wealth data associated with said wealth account number;
(j) generate display data comprising said health data and said wealth data; and
(k) transmit said display data to said user computer.

6. The computerized method of claim 5 wherein said health data further comprises data selected from the group consisting of:
denied claim data, insurance deductible data, and insurance co-pay data.

7. The computerized method of claim 5 wherein said health condition data is selected from the group consisting of:
weight, body mass index, blood pressure, fitness level, blood sugar level, cholesterol level, test results, and prescription data.

8. (canceled)

9. The computerized method of claim 5 wherein said wealth data further comprises data selected from the group consisting of:
inheritance data and gambling data.

10. The computerized method of claim 5 wherein the programming instruction to display data comprising said health data and said wealth data comprises displaying rewards points in said health account and in said wealth account.

11. The computerized method of claim 10 wherein said health account is credited with reward points in association with health-related transactions.

12. The computerized method of claim 10 wherein said wealth account is credited with reward points in association with wealth-related transactions.

13. A computerized system for presenting account information comprising:
(a) an integrated account database comprising: integrated account numbers wherein each integrated account number is:
(1) generated upon receiving a health account number and a wealth account number;
(2) is associated with said health account number;
(3) is associated with said wealth account number; and
(4) user preferences for tracking health data; and
(b) a health database comprising health account numbers and health data associated with said health account numbers, said health data comprising at least:
(1) health insurance payment data;
(2) health insurance claim data; and
(3) health condition data regarding one or more of said individual's medical conditions;
(c) a wealth database comprising wealth account numbers and wealth data associated with said wealth account numbers, said wealth data comprising financial data selected from the group consisting of investment data, brokerage data, mortgage data, spending account data, checking account data, savings account data, credit account data, debit account data, credit score data, and loan data;
(d) at least one server comprising programming instructions to:
(1) receive from a user computer an integrated account number;
(2) retrieve from said integrated account database a health account number associated with said integrated account number;
(3) retrieve from said health database health data associated with said health account number, said health data comprising health condition data selected according to said user preferences for tracking health data;
(4) retrieve from said integrated account database a wealth account number associated with said integrated account number;
(5) retrieve from said wealth database wealth data associated with said wealth account number;
(6) generate display data comprising said health data and said wealth data; and
(7) transmit said display data to said user computer.

14. The computerized system of claim 13 wherein said health data further comprises data selected from the group consisting of:
denied claim data, insurance deductible data, and insurance co-pay data.

15. The computerized system of claim 14 wherein said health condition data is selected from the group consisting of:
weight, body mass index, blood pressure, fitness level, blood sugar level, cholesterol level, test results, and prescription data.

16. (canceled)

17. The computerized system of claim 14 wherein said wealth data further comprises data selected from the group consisting of:
inheritance data and gambling data.

18. The computerized system of claim 13 wherein the programming instruction to generate display data comprising said health data and said wealth data comprises displaying rewards points in said health account and in said wealth account.

19. The computerized system of claim 18 wherein said health account is credited with reward points in association with health-related transactions.

20. The computerized system of claim 18 wherein said wealth account is credited with reward points in association with wealth-related transactions.
